(19) United States
(12) Patent Application Publication
(10) Pub. No.: US 2011/0134421 A1
(43) Pub. Date: Jun. 9, 2011

(54) APPARATUS AND METHOD FOR RAMAN SIGNAL DETECTION

(75) Inventors: Kurt Baldwin, Yorkshire (GB); Simon Webster, Yorkshire (GB)

(73) Assignee: Avacta Limited, Yorkshire (GB)

(21) Appl. No.: 12/997,506

(22) PCT Filed: Jun. 3, 2009
(86) PCT No.: PCT/GB2009/050616

§ 371 Date: Feb. 18, 2011

(30) Foreign Application Priority Data
Jun. 12, 2008 (GB) 0810761.7

(51) Int. Cl. G01J 3/44; G01J 3/10

(52) U.S. Cl. 356/301

(57) ABSTRACT

Raman band detection apparatus illuminates a sample using an illumination source that oscillates in wavelength over a range. The source might for example switch between two wavelengths or might traverse the wavelength range. A wavelength sensitive detector detects radiation emitted by the sample at a series of different wavelengths and a signal processor extracts signals that have a temporal correspondence to the wavelength variation of the illumination at the different wavelengths. One or more Raman bands that might be present will produce a distinctive characteristic of the extracted signals plotted against a spectral axis and relatively simple processing of these spectrally-related time-varying components can then enhance the appearance of the Raman band in a spectral representation based on the processed components. For example, such processing might comprise numerical integration across a spectral plot of the components, or the selection and shifting of certain components, for instance negative components, to overlie others within portions of the spectral representation showing the presence of the Raman band.

The present invention relates to apparatus and a method for detection of Raman signals in electromagnetic radiation. It finds particular application in the detection of a Raman signal in the presence of background which could otherwise mask it.

Raman spectroscopy is used in the study of vibrations of atoms or molecules in a sample. Light can be considered to be made up of particles called photons. When a photon is incident on matter, one of a number of different events can occur. The photon can pass through unchanged, it can be absorbed, or it can be scattered. In the case of scattering, the photon's direction of travel is changed by the scattering event. Usually, the photon's energy is unchanged—this is called elastic scattering. Sometimes the photon's energy is changed—this is called inelastic scattering, or Raman scattering. The magnitude of the change in energy is exactly equal to the energy of a vibration of the matter. Since the ‘allowed’ energies (frequencies) of vibration usually form a well defined set of discrete values, the spectrum of the inelastic scattered light also usually exhibits a set of one or more well defined values (in practice bands known as Raman bands) and these are usually characteristic of the matter concerned.

A Raman spectrometer measures the spectrum of the scattered light. This is usually plotted as intensity (photon counts) vs. wavenumber shift (measured in cm⁻¹, which is proportional to change in photon energy from the incident to the scattered photon). The wavelength of the incident photon can, in principle, be chosen to be anything. In practice, visible, or near-visible wavelengths are usually chosen. The shorter the wavelength (the higher the photon energy), the greater the Raman signal; the un-enhanced Raman signal (measured in photon number) is approximately proportional to the 3^{rd} power of the excitation photon energy. Typical un-enhanced Raman efficiencies are 10⁻⁸ to 10⁻¹² (measured as Raman photons out per excitation photons in).

If the incident photon is absorbed by the matter, or material, then one of the events that may follow is for the material to emit another photon (usually of lower energy). This is sometimes called luminescence. Some of these emitted photons may be indistinguishable from Raman scattered photons, although there is often a small time difference between the absorption and emission processes.

Many ‘real-world’ samples contain contamination from other materials. Often these other materials, or even the sample of interest, will exhibit a degree of luminescence that may overwhelm the Raman signal.

Raman spectrometers typically consist of a source of monochromatic light (usually a laser), some method for delivering this light to a sample, some method for collecting the scattered/emitted light from the sample, a method to filter out the elastically scattered component, and a method for analysing the remaining light to determine the light intensity as a function of its photon energy (wavelength, or colour).

Advances in technology during the late 1980s and early 1990s enabled efficient Raman spectrometers to be made. These advances included very efficient charge coupled device (CCD) cameras and very efficient holographic notch filters. More recently, developments have included dielectric filters, lasers to enable Raman spectroscopy to be carried out over a wider range of excitation wavelengths, and small improvements to the efficiency of diffraction gratings and CCDs. Also, the optics for coupling the light to/from the sample have evolved and now optical fibres are commonly, but not exclusively, used for this purpose.

One of the main limitations of the use of Raman spectroscopy in real-world applications is interference from luminescence. Luminescence (be it fluorescence, phosphorescence, or some other mechanism) is usually much more efficient than Raman scattering. However, efficient luminescence occurs when the incident photon energy lies within (or near to) an electronic absorption band of the sample. These absorption bands are fixed in wavelength for a given material and environment. Hence, when dealing with a luminescent sample, it is common practice to choose an excitation wavelength that is inefficient for luminescence, but still provides reasonable Raman scattering.

By choosing an excitation wavelength that is towards the short wavelength (high photon energy) end of the spectrum, one can avoid (some of the) luminescence as this may occur at longer wavelengths compared to resultant Raman scattering. The Raman scattering will be more efficient, and may also be enhanced by resonant processes. However, the optics are generally more challenging to make (hence more expensive) and the high excitation photon energy can damage the sample. Choosing an excitation wavelength that is towards the long wavelength (lower photon energy) end of the spectrum, luminescence may again be weak as the incident photons do not have sufficient energy to excite the electronic states, but the Raman scattering will also be weaker. It is therefore, from the point-of-view of Raman scattering, often preferable to use an excitation wavelength somewhere away from the extremes of the near-visible spectrum, but this often results in a significant amount of luminescence.

Raman bands are typically a few cm⁻¹ wide (say 2 cm⁻¹ up to 10's cm⁻¹). Luminescence emissions are usually many tens of nanometres, up to ˜100 nm wide. With typical visible excitation wavelengths, 1 nm≈20 to 40 cm⁻¹. Hence, luminescence emission bands are roughly two orders of magnitude or so broader than Raman bands.

Within a typical Raman spectrum, any luminescence appears as a smooth background level, perhaps with some curvature. Background subtraction techniques are known which are used to remove this background and leave the Raman signal as a series of bands above a (near) zero baseline. These known techniques subtract a smooth curve; they do not subtract the noise that is associated with the background. The Raman signal has to compete with this noise level. A large background level will have a large noise level which may still overwhelm a weak Raman signal, perhaps making the Raman bands undetectable.

According to a first aspect of embodiments of the present invention, there is provided apparatus for detecting one or more Raman bands in radiation emitted by a sample in response to illumination which oscillates in wavelength, the emitted radiation being detected as a set of discrete detection signals over a wavelength range, the apparatus comprising a signal processor arranged to:
a. extract time-dependent intensity signals from the detection signals;
b. for the time-dependent intensity signals, determine signals that have a temporal correspondence to illumination of the sample at a selected wavelength or wavelength range of the oscillating illumination, and derive a mean value over time for each such signal; and
c. generate Raman band data values from said derived mean values, the step of generating at least one of the Raman band data values comprising selecting at least two derived mean values and combining them to obtain an enhanced data value.

It has been recognised that it is possible to enhance a spectral representation of Raman bands preferentially over other components such as noise by a relatively simple processing of a set of derived mean values over time as produced in step “b” above. The detection signals are spectrally related because they're produced as discrete measurements across a wavelength range of the emitted radiation. The time-dependent intensity signals and the derived mean values can also thus be spectrally related. A series of the derived mean values usable to create a spectral representation of the emitted radiation has distinctive characteristics where a Raman band lies and these distinctive characteristics allow relatively simple processing of the derived mean values to produce enhancement of the appearance of the Raman band in that spectral representation.

One way of selecting and combining the at least two derived mean values is to select values having a specified polarity, such as negative values, and shift them to a different spectral location in the spectral representation, adding their magnitudes to those of any positive values relevant to that spectral location. Generally, if the spectral shift brings the selected values to a position in the spectral representation where there are values whose magnitudes can be added, there will be enhancement of the appearance of the Raman band. This is because the overall effect of using the derived mean values of step “b” is that noise and other background will tend to be relatively close to zero compared to the distinctive characteristics where the Raman band lies and thus shifting and adding the magnitudes of the derived mean values will only tend to have a significant enhancing effect for the Raman band values.

Another way of selecting and combining the at least two derived mean values is to integrate a consecutive series of derived mean values. In this case, the selection of mean values may simply be done by selecting each next derived mean value in the series and adding it to an existing total for the previous mean values.

In practice, embodiments of the present invention function particularly effectively where a Raman band to be detected has a width which is comparable to the wavelength range of the oscillation of the illumination. An embodiment of the invention may thus further comprise an illumination source for illuminating the sample, which source is controllable to oscillate in wavelength over a wavelength range of the same order as the width of at least one Raman band to be detected. An effective wavelength range in any particular experimental arrangement can be discovered by trial and error. However, in an example, “of the same order” might mean here not more than five times the width, or more preferably within perhaps 50% or less. If the wavelength range is more than ten times the width of a Raman band to be detected, then the band is likely to be undetectable.

In order to detect the Raman band(s), the emitted radiation needs to be detected over a wavelength range which is offset from the wavelength range of the illuminating radiation. An embodiment of the invention for use with a source controllable as above may thus further comprise a wavelength-sensitive detection arrangement for detecting the intensity of electromagnetic radiation emanating from the sample at a plurality of detection wavelengths or wavelength ranges, offset from the illumination wavelength range, to give said set of discrete detection signals.

Putting the above elements together, an embodiment of the present invention might comprise apparatus for performing Raman spectroscopy by generating data values for respective spectral elements of a spectral representation of one or more Raman bands, the apparatus comprising:
i) an illumination source for providing narrow band electromagnetic radiation illumination of a sample, the illumination oscillating in wavelength over a range comparable to the width of a Raman band;
ii) a wavelength-sensitive detection arrangement for detecting the intensity of electromagnetic radiation emanating from the illuminated sample at a plurality of detection wavelengths or wavelength ranges, offset from the illumination wavelength range, to give a set of detection signals; and
iii) a detection signal processor
   the detection signal processor being arranged to process the detection signals by:
a. extracting a set of time-dependent intensity signals from respective detection signals;
b. for the time-dependent intensity signals, determining signals that have a temporal correspondence to the wavelength of the illumination of the sample, and deriving a mean value over time for each such signal; and
c. generating the data values for respective elements of the spectral representation of one or more Raman bands from said derived mean values, the step of generating at least one of the data values comprising selecting at least two derived mean values and combining them to obtain an enhanced data value.

Embodiments of the invention allow a previously ‘undetectable’ Raman signal to be detected and measured, despite being overwhelmed by background noise, or equivalently a signal that appears weak compared to the background noise to improve its signal-to-noise ratio.

Step “a”, which is extracting a set of time-dependent intensity signals from respective detection signals, might be done by subtracting the mean value of the detection signal over time to create a baseline-corrected time-dependent signal that varies around zero. This removes the contribution to the detection signal of the general background level which is not time-dependent.

Then in step “b”, which is determining components that have a temporal correspondence to illumination of the sample, might comprise multiplying the baseline-corrected signal by a reference signal which comprises at least one frequency which is related to a frequency of the wavelength oscillation of the illumination. The required component of the signal may then be found by determining the mean value (over time) of this product of the baseline-corrected signal and the reference signal. For example the reference signal might comprise a fundamental frequency of the wavelength oscillation and/or a harmonic thereof. This effectively removes much of the noise associated with the background level.

Step “c” recognises that, as long as the range of the wavelength oscillation of the illumination is comparable to the width of the Raman bands to be detected, the output from step “b” (the mean value over time of the product of the baseline-corrected signal and the reference signal) can create a distinctive derivative of the Raman band spectrum which can then be summed or integrated in a way that exaggerates the Raman bands in a spectral representation of the data, making them more detectable. For example, if the reference signal comprises a fundamental frequency of the wavelength oscillation of the illumination, the distinctive derivative appears for each Raman band as a “switchback curve” with a positive peak followed by a negative trough. If the values in the switchback curve are numerically integrated, this produces an exaggerated peak centred on the middle of a Raman band. Alternatively, if the moduli of the values in the positive peak and the negative trough are shifted towards each other to overlap, again this gives an accurately positioned and exaggerated peak representing the Raman band. This can be done by shifting the modulus of each value by the same fixed offset value, the direction of offset being determined by whether the value comes from the positive peak or the negative trough.

If the reference signal comprises a first harmonic frequency of the wavelength oscillation of the illumination, the distinctive derivative appears for each Raman band as a central peak with lateral troughs. These values can still be used in detecting a Raman band by taking the magnitude of the values in the central peak and summing the moduli of the values from the lateral troughs but shifted by a fixed offset value towards each other to overlap the central peak. For example, the fixed offset value might bring the lateral troughs to sit at the centre of the central peak. In this case, it is necessary to distinguish which lateral trough is which so that the moduli of the values from each trough can be shifted in the correct direction. This can be done by referring to the “switchback curve” mentioned above, relating to the fundamental frequency. The positive and negative parts of the switchback curve will map onto different respective lateral troughs and can thus be used to distinguish them.

The fixed offset values mentioned above in relation to step “c” are preferably, in both cases, close to or equivalent to the amplitude of wavelength oscillation of the illumination. As long as the peak-to-peak range of that wavelength oscillation is approximately equal to the width of the relevant Raman band, this preserves a degree of accuracy in terms of width of the Raman band in a representation of it based on step “c”. Also, if the illumination oscillates across a wavelength range at least approximately equal to the spectral range of a Raman band to be represented, it generally means the “distinctive derivative” of the Raman band is most pronounced.

The wavelength variation of the illumination and/or the reference signal can be represented by, for example, a smooth sine wave meaning the reference signal traverses to and fro across the wavelengths in a wavelength range in a continuous manner; or it can be represented by a discrete sine wave, meaning the reference signal traverses to and fro across the wavelengths in a wavelength range repeatedly showing the wavelengths towards the ends of the range plus at least one intervening wavelength; or it can be represented by a square wave in which the reference signal switches between the two wavelengths at the ends of the range.

In embodiments of the invention according to its first aspect, the wavelength sensitive detection arrangement preferably receives electromagnetic radiation across a spectral range greater than the width of a Raman band. This allows it to produce intensity signals across the Raman band while the band itself moves across the wavelength sensitive detection arrangement. These intensity signals still contribute by means of step “c”, combining the magnitudes of the derived mean values for two or more detection signals, to the representation of a Raman band.

The reference signal can be supplied, in use, to the illumination source so as to generate the wavelength oscillation of the illumination. This ensures a frequency match when it comes to analysing the detection signals. However, it is not essential to use the same signal.

A spectral representation of a Raman band can include data derived from both the fundamental reference frequency and the first harmonic of the reference frequency. It is noted that higher harmonics may also be used to refine the resultant spectrum further.

In embodiments of the invention, it is recognised that oscillating the excitation radiation in wavelength creates an output from the sample in which the Raman bands are oscillated to and fro spatially over an array of detectors. The spatial scanning of these Raman bands necessarily has frequency components related to the oscillated excitation radiation, making the bands detectable. By processing the time-resolved responses of individual detectors against their respective wavelengths, one can create a direct representation of a Raman band in a spectral display.

As mentioned above, it is preferable that the peak-to-peak wavelength range encompassed by the oscillation of the illumination is of the same order as the width of a Raman band it is intended to detect as this enhances the signal to noise ratio of the Raman signal. If the wavelength range is too great or too small, for example by a factor of ten with regard to the width of the Raman band, the Raman signal may become undetectable. It may be preferable to use a more complicated wavelength variation function, for example a superposition of two or more oscillations each with different amplitude “a” and with different temporal frequencies. This allows the selection of a representation of a Raman band which has been achieved with the best match between the wavelength range and the width of the band. It also deals with the potential difference in width of the Raman bands for a single sample, allowing one analysis operation to give efficient detection of differently sized bands.

According to a second aspect of the present invention, there is provided a method of detecting one or more Raman bands in radiation emitted by a sample in response to illumination which oscillates in wavelength, the emitted radiation being detected as a set of discrete detection signals over a wavelength range, the method comprising:
a. extracting time-dependent intensity signals from the detection signals;
b. for the time-dependent intensity signals, determining components that have a temporal correspondence to illumination of the sample at a selected wavelength or wavelength range of the oscillating illumination and deriving a mean value over time for each such component; and
c. generating Raman band data values from said derived mean values, the step of generating at least one of the Raman band data values comprising selecting at least two derived mean values and combining them to obtain an enhanced data value.

Embodiments of the invention in its second aspect may additionally carry out any or all of the steps described above in relation to the invention in its first aspect, such as illuminating the sample with radiation which oscillates in wavelength over a wavelength range of the same order as the width of at least one Raman band to be detected. In another example, an embodiment of the invention in its second aspect may comprise detecting the intensity of electromagnetic radiation emitted by the illuminated sample at a plurality of detection wavelengths or wavelength ranges, each detection wavelength or wavelength range being outside a wavelength range over which the sample is illuminated, to give said set of discrete detection signals.

Any feature described in relation to one aspect or to any one embodiment of the invention may be applied in relation to one or more other aspects or embodiments of the invention if appropriate.

Raman detection apparatus according to an embodiment of the present invention will now be described, by way of example only, with reference to the accompanying figures in which:

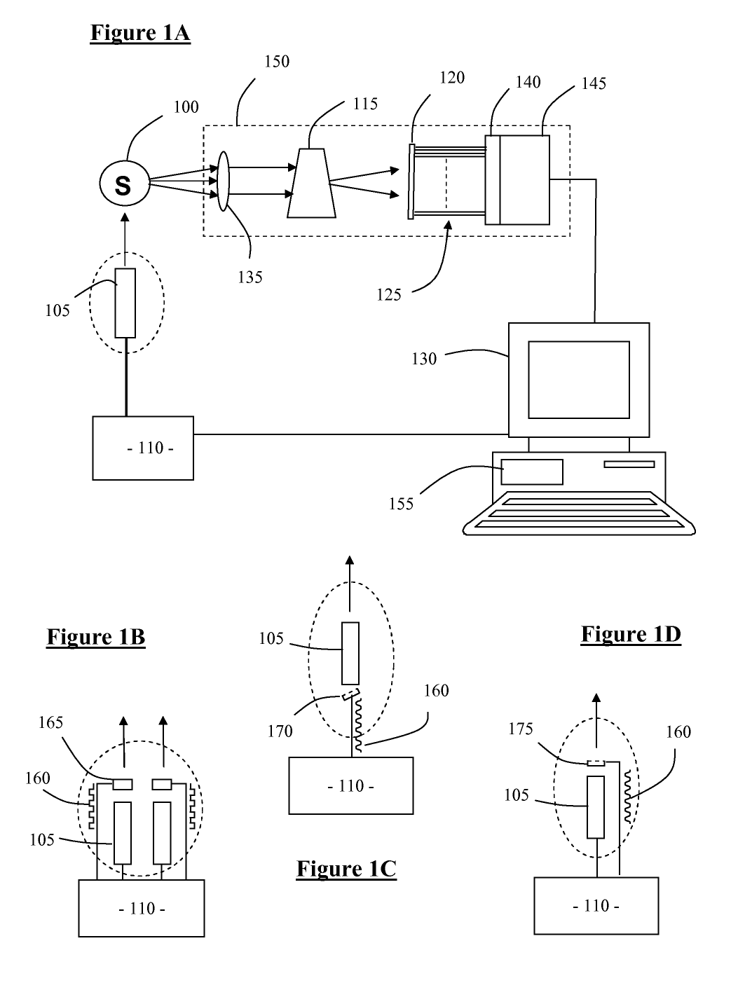

FIGS. 1A, 1B, 1C, 1D show schematic diagrams of the detection apparatus with alternative illumination source arrangements;

FIG. 2 shows schematically the light incident on each of a set of five detectors, in use of the apparatus of FIG. 1A over time;

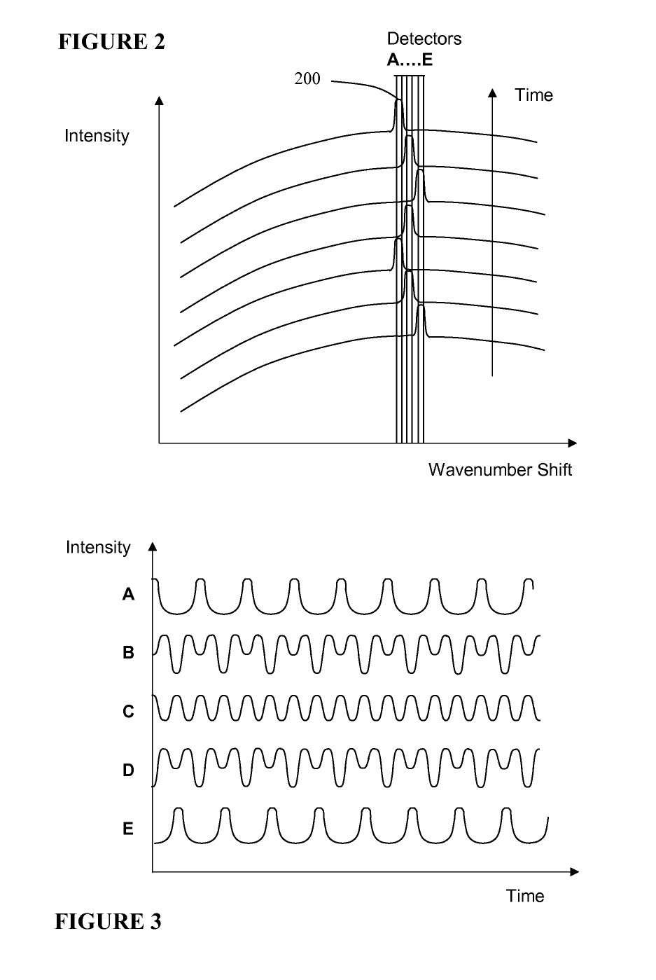

FIG. 3 shows a schematic illustration of the signal received at individual ones of the detectors of FIG. 2 over time;

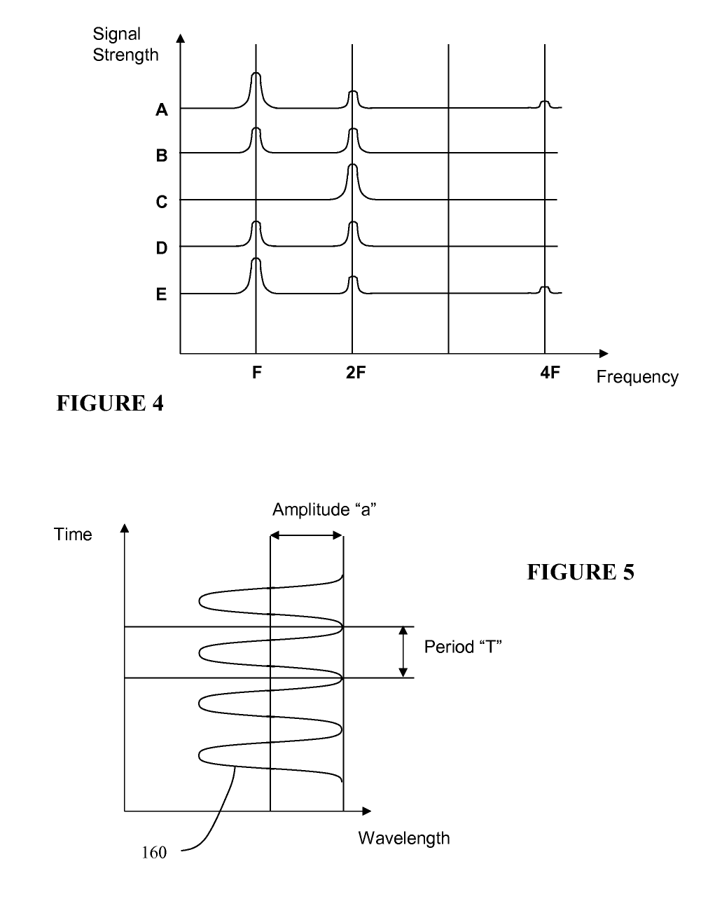

FIG. 4 shows a schematic illustration of frequency components of the signals shown in FIG. 3;

FIG. 5 shows a schematic illustration of the wavelength of excitation radiation driven by a reference signal with sinusoidal oscillation for use in exciting a sample to produce the signals shown in FIG. 3;

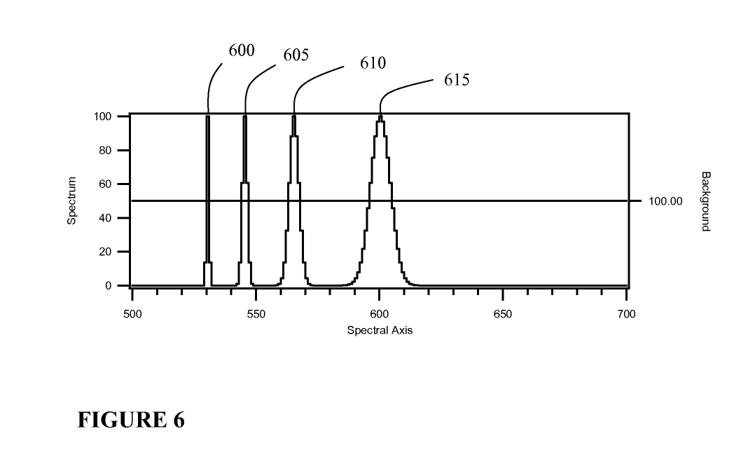

FIG. 6 shows an ideal Raman spectrum of the type the detection apparatus might be used to detect, having no noise and a flat background;

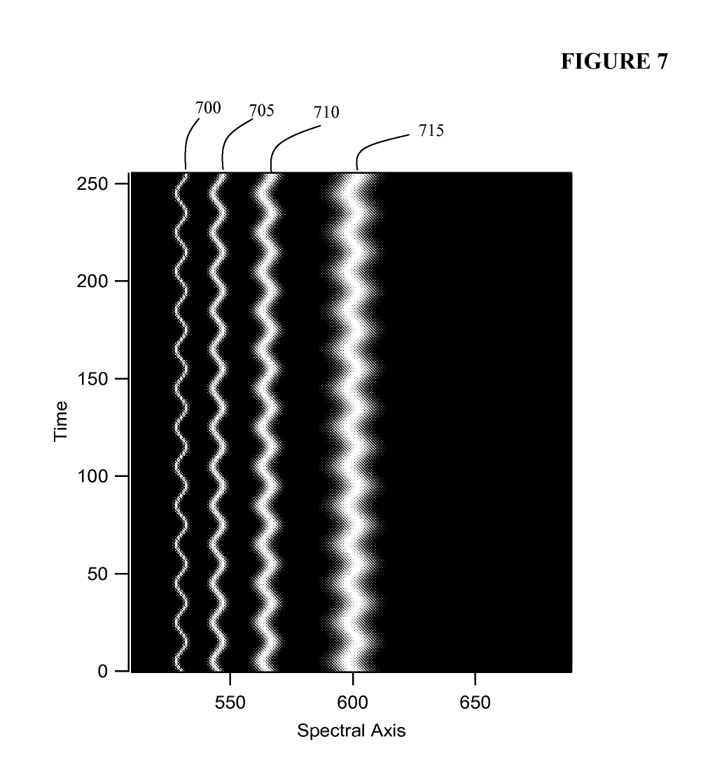

FIG. 7 shows simulated plot of intensity against wavenumber over time that might be recorded for an extended set of the detectors of FIG. 2 using the ideal Raman spectrum of FIG. 6;

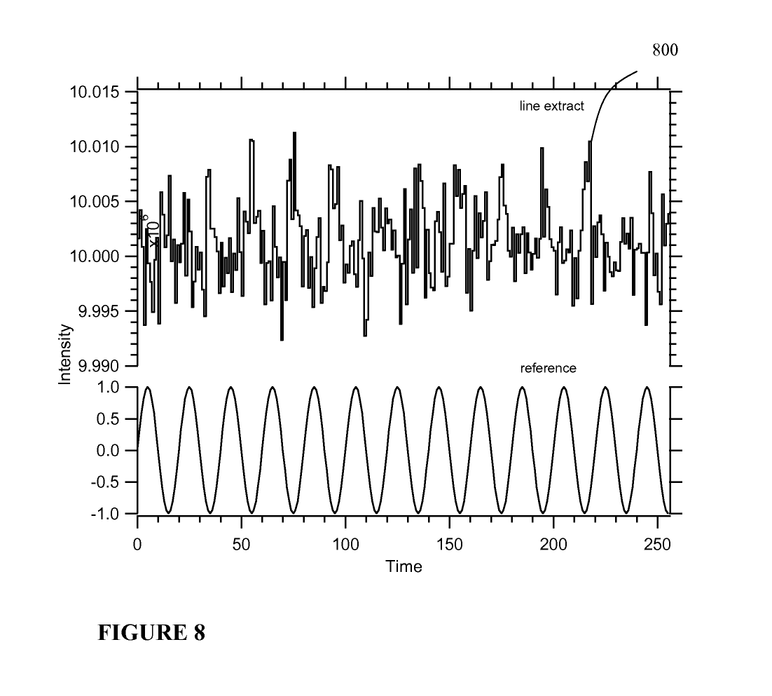

FIG. 8 shows an intensity versus time plot for the signal from a single detector, together with the reference signal of FIG. 5;

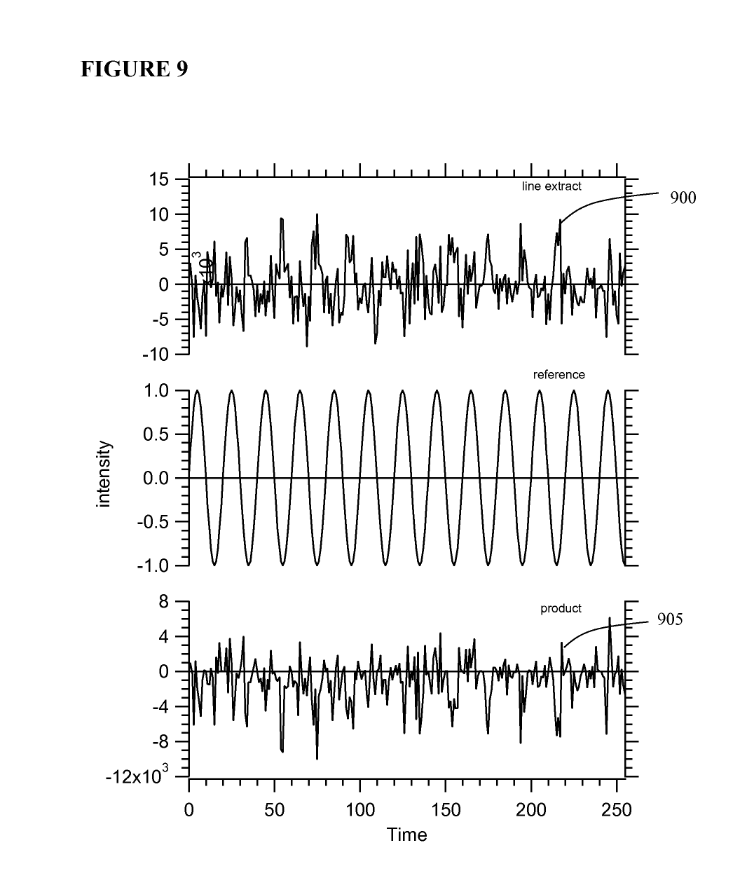

FIG. 9 shows the intensity versus time plot of FIG. 8 with mean value subtracted, the reference signal and the product of the two;

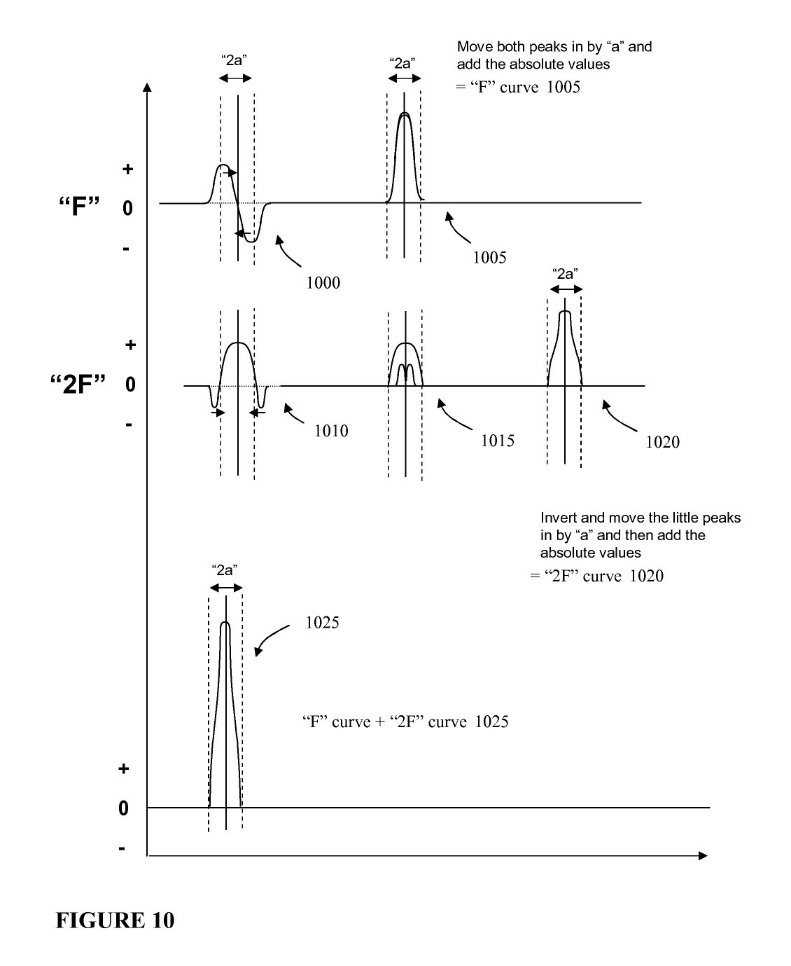

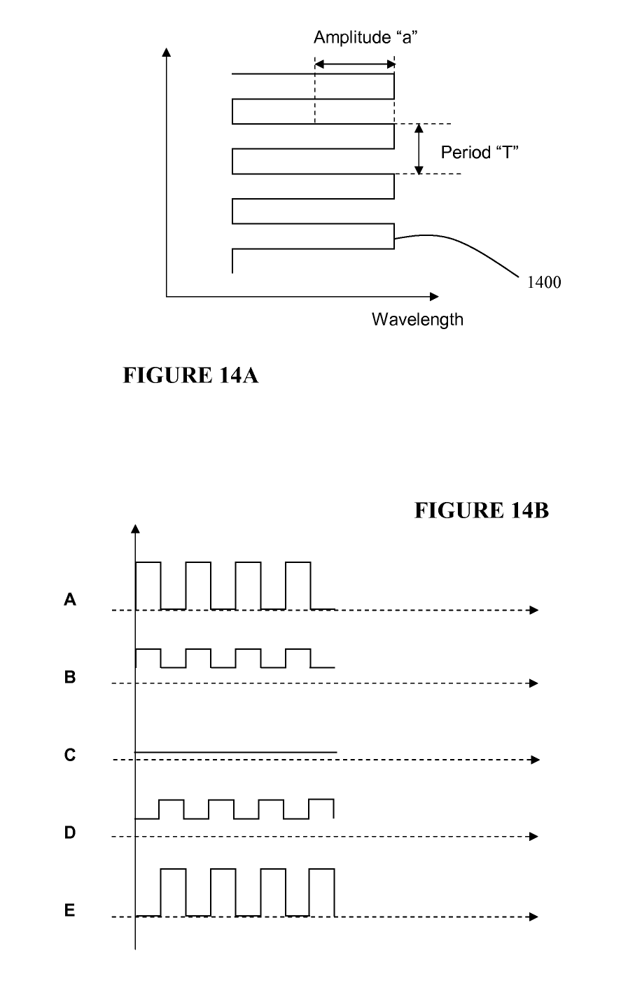

FIG. 10 shows a schematic illustration of spectral shift processing which can be used for generating a representation of a Raman band from the signals shown in FIGS. 3 and 14B;

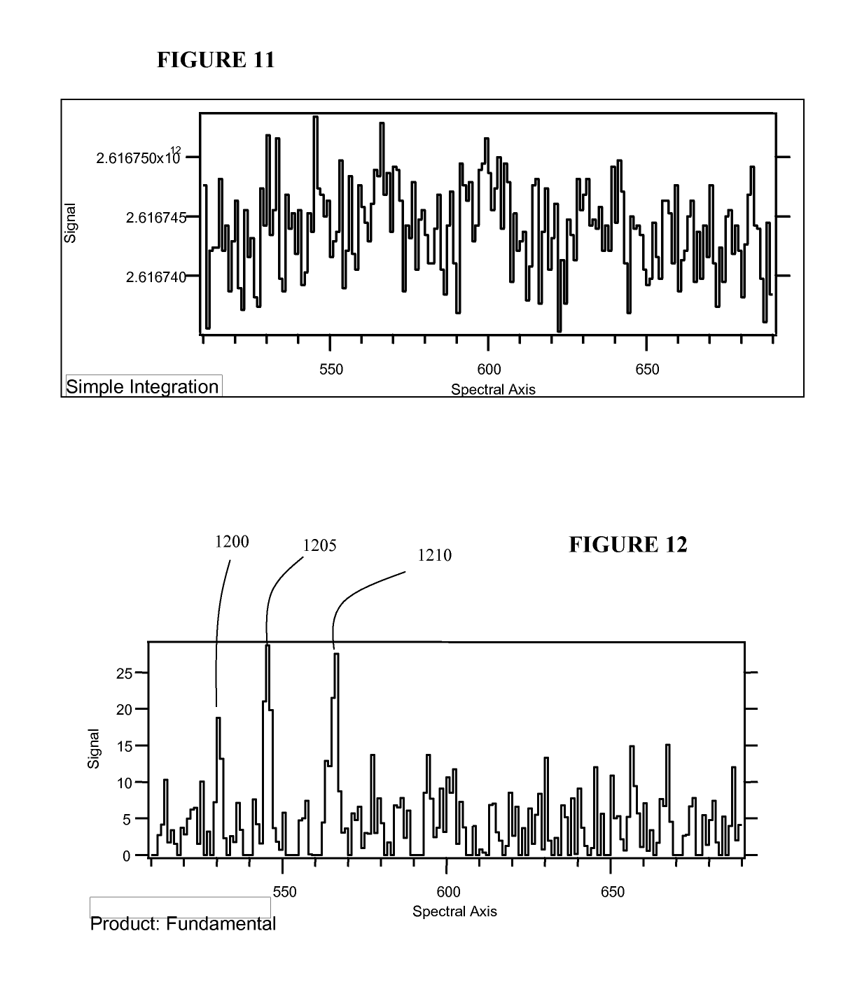

FIG. 11 shows the spectrum obtained using a conventional methodology without oscillation of the excitation radiation;

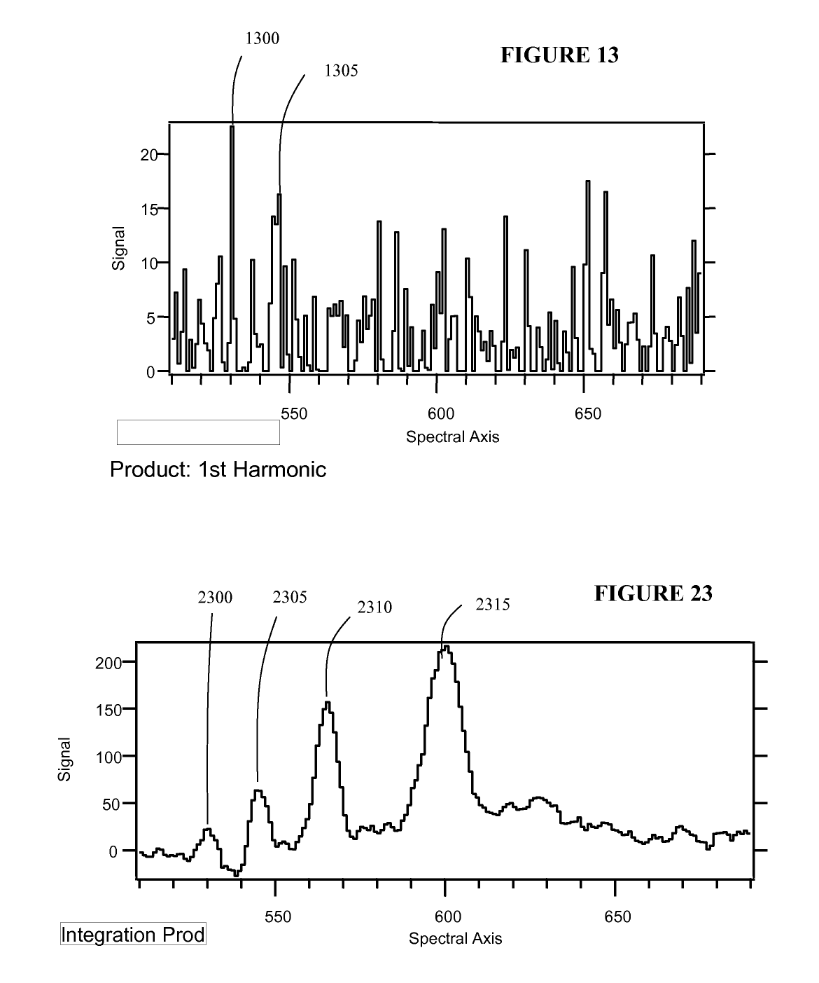

FIGS. 12 and 13 show spectra obtained using an embodiment of the invention based on sinusoidal variation of the excitation wavelength, firstly for the fundamental frequency of the reference signal and secondly for the first harmonic thereof;

FIG. 14A shows a schematic illustration of the wavelength of excitation radiation with square wave oscillation for use in exciting a sample in use of the detection apparatus in an alternative procedure;

FIG. 14B shows a schematic illustration of the signal received at individual detectors in response to excitation radiation as shown in FIG. 14A;

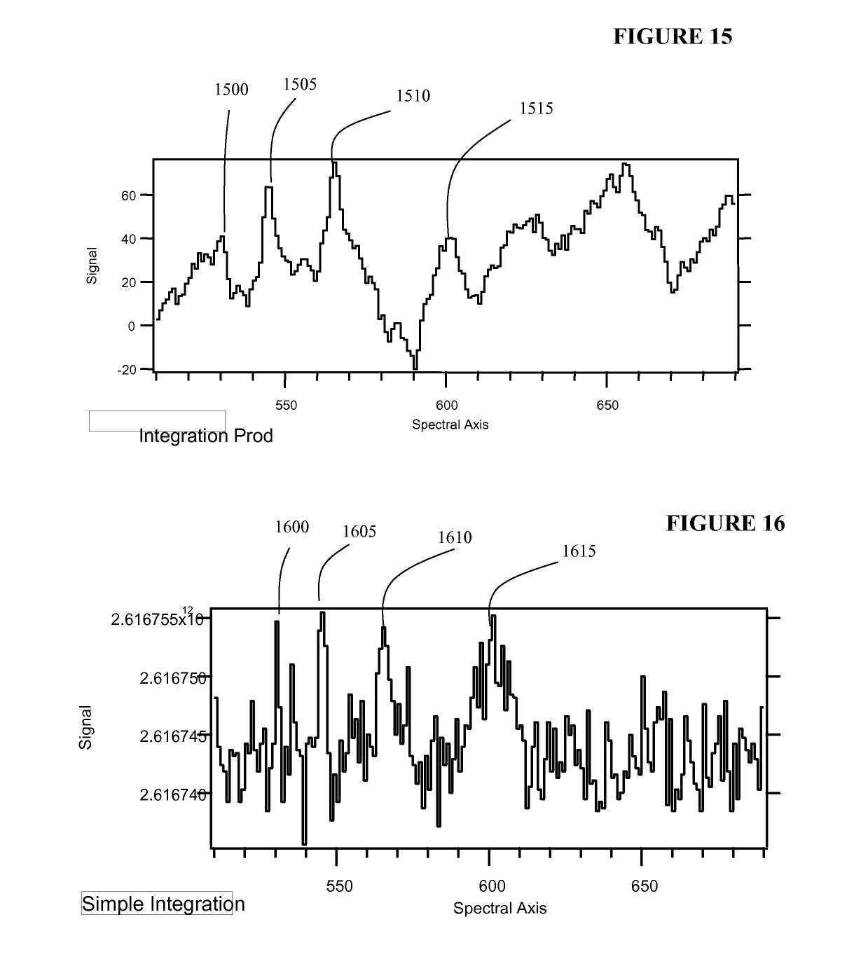

FIG. 15 shows a spectrum obtained using an embodiment of the invention based on the second method for creating the representation of the Raman spectrum;

FIGS. 16 to 19 show spectra obtained using a simulated Raman spectrum having different parameters from those of spectra of FIGS. 11 to 15 in that the Raman signal is scaled to be more intense and with all the other parameters being the same. These spectra have been obtained respectively using:
a conventional method
sinusoidal variation and the fundamental frequency, and a first method of analysis
sinusoidal variation and the first harmonic, and the first method of analysis,
sinusoidal variation and a second method of analysis;

FIGS. 20 to 23 repeat the format of FIGS. 16 to 19 but using double the amplitude of oscillation of the reference signal; and

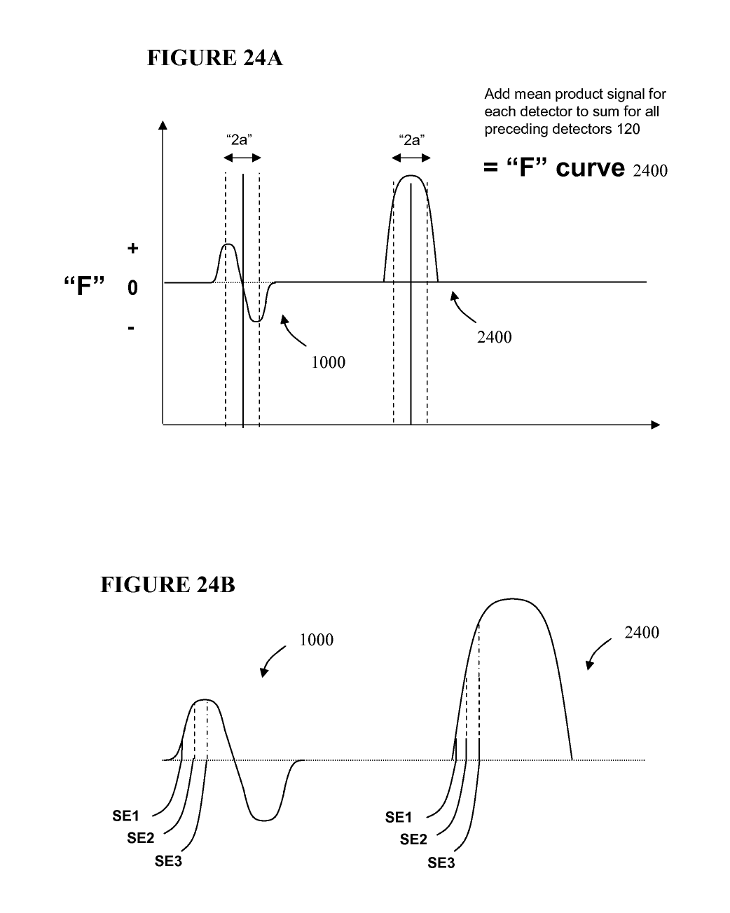

FIG. 24 shows a schematic illustration of numerical integration processing which may be used instead of the processing shown in FIG. 10, for generating a representation of a Raman band from the signals shown in FIG. 3 or 14B.

It should be noted that the figures are not drawn to scale.

### EQUIPMENT

Referring to FIG. 1A, the Raman detection apparatus comprises an illumination source 105 which illuminates a sample 100 with electromagnetic radiation. The illumination source 105, shown inside a dotted oval outline in FIG. 1A, is driven by a control system 110 which can be used to apply a reference signal 160 (shown in FIGS. 1B to 1D) having the effect of varying the wavelength of the emitted electromagnetic radiation. At least some of the electromagnetic radiation given out by the sample 100 is collected and directed into a spectrometer 150 that may consist of:
a filter (and collection device) 135 to remove the majority of elastically scattered radiation
a dispersive element 115 such as a diffraction grating or prism to create a spatial spread of the remaining radiation according to wavelength
an array of detectors 120 such as elements of a charge-coupled device (CCD) to receive the spatially spread radiation and give a measure of intensity of radiation received at each detector. These detectors 120 produce a set of signal channels 125, each of which relates to a small wavelength range, or spectral element, across the spectrum of the spatially spread radiation
an amplifier 140 for the signal channels 125
an analogue to digital converter 145 (“ADC”) for digitising amplified signals carried by the channels

The digitised data output from the ADC 145 can then be processed by a detection signal processor 155 embodied in software installed on a computing platform 130.

It might be noted that the amplifier 140 and ADC 145 are usually integrated into a CCD (“charge-coupled device”) camera, and are ‘transparent’ to the end user. The basic requirement is just for a (preferably linear) array detector, which is conveniently provided by a CCD type detector but could be anything that acts as an array of detector elements.

In outline, embodiments of the invention use an illumination source of electromagnetic radiation 105 that can be oscillated in wavelength by a few cm⁻¹ (i.e. of the order of the width of a Raman band). The measured spectrum received at the detectors 120 will consist of a nearly static background signal, its associated noise, and a superimposed Raman signal which oscillates along the spectral axis in synchronisation with the oscillation of the illumination source 105. By measuring the resultant signal that is oscillating in synchronisation with the light source, a weak Raman signal can be extracted from a large, noisy background since the background should not have a particular frequency response—that is, it will be white noise. Embodiments of the invention use methods to extract the components of the signals at the detectors that vary in synchronisation with the illumination source 105, and then to assemble these by summing or integration to reconstruct the Raman signals even where previously the Raman signal was undetectable above background noise.

Referring to FIGS. 1B to 1D, suitable illumination sources 105 are described below, the source 105 being shown in each case within the same dotted oval outline as that of FIG. 1A.

Referring to FIG. 1B, two lasers 105 may be used, these being chosen to emit radiation at two different wavelengths (frequencies), approximately the width of a typical Raman band apart (few cm⁻¹). The optical path of the radiation from one laser is coincident with the radiation from the second laser before or as it is incident on the sample 100. The radiation from the two lasers 105 is then switched in alternation so that the radiation incident on the sample 100 is effectively chopped between the two illumination sources 105. The lasers 105 themselves might be switched on and off but a more optically stable arrangement might be to use optical modulators or a chopper wheel 165 driven by reference signals 160 that are 180° out of phase so as to modulate the output of the lasers 105 in alternation.

Each laser 105 has a narrow spectral range, that is, significantly less than the width of a Raman band to be detected and perhaps for example sub 1 cm⁻¹. Some laser technologies emit much narrower lines than this and could equally well be used.

More than two lasers 105 may be chosen, each emitting radiation at different wavelengths. The radiation incident on the sample 100 can be chopped between/among these different lasers 105.

Referring to FIG. 1C, in a second arrangement, the output from a single laser 105 can either be tuned between two (or more) discrete wavelengths, or smoothly oscillated between two extreme wavelengths. One embodiment of such a laser source is a diode laser with an external Bragg feedback grating 170 which is tilted under the control of a reference signal 160 using a piezo mount.

Referring to FIG. 1D, in a third arrangement, a light source 105 that emits all (many) wavelengths between the maximum and minimum wavelengths is used, with a monochromator 175 (such as a diffraction grating, Fabry-Perot etalon, or otherwise) driven by a reference signal 160 to filter its output to select one narrow band of wavelengths as the resultant emission.

Referring again to FIG. 1A, with regard to the detectors 120, there are many suitable single element and multiple element detectors available. A preferred spectral detector would consist of a linear (or two dimensional but used as linear) array of elements such as a CCD. Other technologies such as avalanche photodiodes (APDs) and photomultipliers are now becoming available in array formats. Important characteristics for a detector 120 to be used in embodiments of the invention are for it to be very sensitive to the appropriate wavelengths of light, to be low noise, and to be able to read out the signal fast. The speed of readout is important for a practical device where the source is oscillated at a particular frequency (typically in the range of approximately kHz to Hz), and hence the light intensity from each pixel on the detector needs to be read at this ‘frame rate’ times the number of elements in the detector array.

The wavelength range of each detection channel 125 needs to be small enough to be able to give a sufficiently high sampling rate across detected Raman bands for the Raman bands to be adequately re-constructed. For example, a reasonable number of detector elements 120 would give several, say five to twenty, detector elements 120 covering a typical Raman band. A known type of detection arrangement that would be suitable is a dispersive spectrometer. Physically, most dispersive spectrometers spread incoming light into a line, in which one end of the line corresponds to short wavelengths and the other end of the line to long wavelengths. Detector elements 120 also have a finite physical size (active area). The two sides of each detector element 120 correspond to slightly different wavelengths, with a continuous spread of wavelengths between. This determines the pixel resolution of the spectrometer. If one spread the light into a wider line, or used a detector with smaller elements 120, then the pixel resolution would improve. In practice, one also typically has an entrance slit on the spectrometer. This slit acts as a finite aperture in the dispersive direction. If one has a narrow slit, one can get the spectrometer to be limited by the pixel resolution, but one will not get much light through the slit. So one broadens the slit to let more light in, but the image of the slit on the detector elements 120 can be a size more than one element. The spectral resolution is now limited by the slit width.

One could use a spectrometer in which there were more than twenty detector elements 120 covering a single Raman band but to get most of the entire Raman spectrum (which usually consists of many separate bands) one may then need a much longer and possibly impractical detector.

Regarding instrumentation, there are many companies that manufacture Raman spectrometers. The usual requirements for these instruments are a narrow line-width laser (typically less than 1 cm−1), an optical filter to remove most of the Rayleigh scattered light, and an optical spectrograph with a multiple-element, low noise, high quantum efficiency detector. These components will not be described here as they are well known in the industry and in the literature. The particular features that are needed for an embodiment of the present invention are as follows:
a light source whose wavelength can be varied (with an amplitude typically of the order of several cm−1 [e.g. 3 cm−1 to 20 cm−1 amplitude, depending upon the application]) but still provide an ‘instantaneous’ narrow line-width
a multiple element detector that can be read out fast (for example, a spectrum every 1 to 200 ms).

Many different components are available to provide these features that can have a wide range of specifications. As an example, the light source can be achieved using an external cavity tuneable diode laser. One such family of lasers is manufactured by Sacher Lasertechnik. For example, the Littman/Metcalf Lion TEC 500 or the Littrow Lynx TEC120 laser are suitable. Alternatively, one can use two lasers and simply chop between them. Any pair of Raman compatible lasers can be used provided their wavelengths are spectrally separated by an appropriate amount.

For the detector, many manufactures make CCD devices that are suitable for Raman spectroscopy, and that can read out spectroscopic lines at appropriate speeds. One such camera is a Princeton Instruments Pixis 2K, which can read spectra at a rate of up to 90 spectra per second. Again, there are many other appropriate cameras in this range, and made by other manufacturers.

### Reference Signals 160 and Detector Responses

Referring to FIG. 2, the principle behind embodiments of the invention can be understood by considering the simple case of five detectors 120, labelled in FIG. 2 as A . . . E. Taking a set of five detectors A . . . E of an array of detectors 120 and applying a sinusoidal wavelength variation of the excitation radiation having a peak-to-peak amplitude comparable to the combined bandwidth of the five detectors, the effect will be that a Raman peak 200 that happens to lie within that combined bandwidth during the sinusoidal variation will track to and fro in time across the five detectors A . . . E. That is, the Raman peak 200 will oscillate across the detectors 120.

Referring to FIG. 3, the detected intensity variation over time for each channel will be determined by the position of its respective detector 120. The detectors A, E at the outer ends of the oscillation of the Raman peak will “see” the peak only once during its oscillation and exactly out of phase with each other. The detectors B, D which are neither at the ends nor the middle of oscillation of the Raman peak will “see” the peak twice each, unevenly spaced and again out of phase with each other. The detector C will “see” the peak twice, evenly spaced, and thus in frequency terms at the first harmonic of the fundamental frequency of the oscillation of the Raman peak.

Thus the responses of the five detectors A . . . E have a definite phase and harmonic frequency relationship with each other and this relationship can be exploited to enhance significantly the ability of the system to discriminate a small Raman signal from background noise.

Referring to FIG. 4, the frequency components of the responses of the five detectors 120 can be seen to be a combination of the fundamental frequency and the first harmonic, and higher harmonics, except for the central detector C whose response is predominantly at the first harmonic. The position of detector C gives the centre of a Raman band but there is considerably more information available from the rest of the detectors of the set of five, both in terms of position and width of the Raman band, and embodiments of the invention seek to exploit this.

In practice, many more detectors would be used. In the following examples of Raman signal detection according to embodiments of the invention, intensity data that would be produced by a full array of detectors 120 is processed to create representations of Raman bands, using different reference signals and forms of oscillation of the excitation radiation.

### Method 1, Using Sinusoidal Reference Signal

Referring to FIG. 5, in a first embodiment of the invention, a sinusoidal reference signal 160 applied to the excitation source, to modify the output of the laser or lasers 105, has period “T” and amplitude “a”. The signal processing involved in generating a Raman spectrum using this oscillation of the excitation source and intensity data obtained on channels 125 connected to an array of detectors 120 is described below.

Referring to FIG. 6, an ideal Raman signal for detection has a set of peaks 600, 605, 610, 615 with no noise and a flat background. In the example shown, the signal spectrum consists of four distinct Raman bands with different widths (Gaussian line shapes, 1σ: 0.5, 1, 2, 4 spectral units), and each with a peak maximum of 100 counts. The background is simply a flat uniform level of 100 counts. However, to create a data set which represents an actual light intensity signal output by the array of detectors 120 in use, the idealised Raman signal of FIG. 6 would have to be adjusted with appropriate scaling factors and with added, appropriately calculated random noise. In particular, the background level is multiplied by a scaling factor, the signal spectrum is multiplied by a different scaling factor, the signal spectrum is also offset in wavenumber according to the “time” of the spectrum, the oscillation amplitude and the period.

Referring to FIG. 7, a type of time-spectrum intensity plot that might be obtained from a set of detectors 120 in the case of a sinusoidal reference signal 160 shows the effect of the four Raman peaks as four spectrally offset sinusoidal traces 700, 705, 710, 715. The time-spectrum intensity plots shown here have the following parameters:
background scaling: 10,000 (corresponding to a background level of 10⁶ units)
spectrum scaling: 0.5 (corresponding to a peak height of 50 units)
spectrum oscillation period: 20 time units (pixels along the spectral axis as shown)
spectrum oscillation amplitude “a”: 2 wavenumber units (pixels along the spectral axis as shown, each pixel being the intensity recorded from a single detector element 120)
shot noise: 1σ

It might be noted that FIG. 7 is intended to show the principle only. In practice, the Raman bands would usually be visually indistinguishable from the background.

Referring to FIGS. 5, 6 and 8 to 13, in order to detect and form a graphical representation of Raman bands such as those shown in FIG. 6 and present in a sample output, the following signal processing steps are carried out:
1. Generate or obtain a reference signal which corresponds directly to the reference signal 160 creating the wavelength oscillation of the excitation source 105 whose fundamental will be sin(2π·t/T), where t is time, as shown in FIG. 5. (Indeed this reference signal may conveniently be the same signal 160 as that used by the control system 110 of FIG. 1 to produce the wavelength oscillation of the excitation source 105 and is referred to as the reference signal 160 hereinafter.)
2. For each detector channel 125, and therefore for a particular spectral data point (or pixel along the spectral axis of a graphical representation), extract an intensity vs. time signal 800 as shown in FIG. 8 for the spectral value 532 units.
3. Calculate the mean value of this signal, 10,001,200 for the signal 800 shown in FIG. 8, and subtract this mean value from the whole signal, effectively making the signal oscillate about zero as shown in the uppermost curve 900 of FIG. 9.
4. Multiply this by the reference signal 160 from step 1 above to create a resultant product signal as shown in the lowermost curve 905 of FIG. 9.
5. Calculate the mean value from this result, −1066 in the case of the lowermost curve 905 of FIG. 9 with the negative value indicating it is in anti-phase, (effectively a “DC” level in terms of the detector output), and store.
6. Repeat steps 2 to 5 above for all detector channels 125 and therefore spectral data points and plot the “DC” levels of step 5 against their spectral position, this producing a “switchback” curve 1000 as shown schematically in FIG. 10, for each resolved Raman band.
7. Create a set of spectral data ‘bins’, and for each value calculated in step 5 add its absolute (magnitude) value to the spectral bin that is + or − the oscillation amplitude ‘a’ away (spectrally), the + or − determined by the sign of the value, obtaining a narrowed peak 1005 as shown in FIG. 10. A spectral data bin in this context might be for example a location in a data store which has been assigned to a short spectral range, usually but not necessarily matching the spectral range that will fall on a single detector element 120.
8. Repeat steps 1 to 6, but replacing the reference signal 160 in step 4 with its first harmonic (sin(4π·t/T)). This produces, instead of a switchback curve, a peaked curve 1010 with inverted side sections as shown in FIG. 10. In this case, step 7 is conducted differently. Positive values from step 5 are added to the directly corresponding spectral bin, and negative values are added to the spectral bin that is + or − the oscillation amplitude ‘a’ away (spectrally), the + or − determined by the sign of the corresponding value from the reference signal product for this detector element from step 7 for the fundamental of the reference signal. This produces a peak 1020 where the moduli of the inverted side sections have been added to the main peak.
9. The spectra from steps 7 and 8 can be added together to give the final spectrum 1025.

Instead of referring to the fundamental of the reference signal product to determine the + or − direction of the spectral bin a value will be added to, an alternative approach would be to set a flag in a memory location when a significant series of negative values had been assigned to spectral bins. A following series of negative values would then be assigned to spectral bins in the opposite spectral “direction”. However, this approach could be less dependable in processing noisy data.

Referring to FIG. 10 in more detail, step 7 for the fundamental reference signal 500 and for its first harmonic are as follows. After step 6, the “DC” levels of step 5 plotted against their spectral position gives, for each Raman band, a “switchback” curve 1000 or a peaked curve 1010 having a positive portion and one or two negative portions. The full extent of the spectral width of the curves 1000, 1010 will be greater than twice the amplitude “a” of the reference signal by an amount determined by the width of the Raman band. The midpoint of the curves 1000, 1010 corresponds exactly to the midpoint of the Raman band when the excitation source passes through the midpoint of its wavelength oscillation. The intention of step 7 & 8 is to narrow the representation of a Raman band offered by the curves 1000, 1010 and, if the width of the Raman band is of the same order as the variation in wavelength of the excitation source 105, this will achieve a good approximation to the actual width of the Raman band.

Step 7 in the case of the fundamental frequency has the effect of moving the positive and negative peaks of the switchback curve 1000 inwards, in a spectral direction for each of them that crosses the midpoint of the Raman band when the excitation source passes through the midpoint of its wavelength oscillation. This is indicated by the small arrows shown in FIG. 10. By using the moduli of the “DC” values of step 5, the negative peak is effectively inverted and added to the positive peak to obtain a narrowed resultant peak 1005 labelled as the “F” curve on FIG. 10.

Step 8 in the case of the first harmonic has the effect of leaving the positive peak of the three-part curve 1010 where it is but bringing in the two negative portions, again as indicated by the small arrows shown in FIG. 10. Again, by using the moduli of the “DC” values of step 5, the negative portions are effectively inverted and added to the positive peak to obtain the resultant peak 1020 labelled as the “2F” curve on FIG. 10.

Adding the “F” curve and the “2F” curve gives a more intense and therefore more detectable curve 1025 which is a good approximation to the Raman band of interest.

It might be noted that in practice, because data obtained in Raman spectroscopy will be stochastic, there may be spectral data bins within the Raman band that do not have any values, or only one value, in them.

FIGS. 11 to 13 show spectral results that were obtained in relation to a sample having the four Raman bands shown in FIG. 6, firstly processed using a conventional Raman spectroscopy method with no oscillation of the excitation source and then using sinusoidal oscillation of the excitation source 105 together with the steps described above. A similar set of parameters have been used as described above with reference to FIG. 7 but with an integration time of 262144 (2̂18) and with a spectrum scaling factor of 0.5 and background of 10,000.

FIG. 11 relating to the conventional Raman spectroscopy method shows almost indistinguishable spectral information from the background noise.

FIG. 12 shows the result using a sinusoidal reference signal 160 and oscillation of the source 105 with data processing based on the fundamental frequency. The Raman bands 1200, 1205, 1210 whose width is not too dissimilar to the oscillation amplitude are enhanced significantly using this method. However, the band whose width is broad (and also any bands whose widths are too narrow) has effectively disappeared.

FIG. 13 shows the result using a sinusoidal reference signal and oscillation of the source 105 with data processing based on the first harmonic. The first harmonic data show some contribution which may be useful to enhance the signal representing two of the Raman bands 1300, 1305, but the noise within this spectrum is fairly large.

Thus there is a clear enhancement in the intensities of the resultant signals from the fundamental frequency analysis when compared to the conventional method; each of these simulations used equivalent parameters (signal level, background level, integration time, noise).

### Method 1, Using a Square-Wave Reference Signal

Referring to FIG. 14A, in a second embodiment of the invention, a square wave reference signal 1400 applied to the excitation source 105 has period “T” and amplitude “a”. This may be provided as a discrete chopping between two wavelengths either by a single source 105 or by switching the output between two (or more) different emitters.

Referring to FIG. 14B, looking at the intensity detected across a set of five detectors A . . . E, in the same manner as in relation to FIG. 3, the outputs of the five detectors will show square waves, again varying in phase and magnitude.

The situation with square wave excitation (for instance where the output of a laser 105 oscillates between two discrete excitation wavelengths) is very similar to that with sinusoidal oscillation of the excitation radiation and the methodology is almost the same as described above. However, in this case, only the fundamental signal is used and not the first harmonic, and a square wave is used as the reference signal instead of the sinusoidal wave. Hence the protocol for analysing the data thus obtained is the same as for steps 1 to 7 described for the sine wave reference signal.

### Method 2

The ‘encoded’ data from step 6 of the above protocols can be treated in different ways to provide a representation of the Raman spectrum. A second method is for step 7 to be simply to integrate this data numerically. This results in an approximation to the original Raman spectrum, wherein any narrow peaks are effectively broadened to the amplitude of the oscillation of the excitation wavelengths, and where the baseline exhibits a pseudo random walk.

In more detail, the starting point for the numerical integration of Method 2 in the case of a single Raman band would be the “switchback” curve 1000 of FIG. 10 which shows a plot of the mean values of the product signals for each detector 120 receiving the relevant Raman radiation from the sample and thus relating to spectral elements of the Raman band.

Referring to FIG. 24A, the numerical integration method takes the mean value of the product signal 905 for each detector 120 in turn, and adds it to the sum of the mean values of the product signals 905 for all the preceding detectors 120. In the case of the switchback curve 1000, this generates a peaked curve 2400 which is somewhat broader (by the oscillation amplitude) than the equivalent curve 1005 obtained with Method 1.

FIG. 24B shows the steps of the numerical integration method in slightly more detail. The switchback curve 1000 is plotted from the mean values of the product signals which relate to individual detectors 120 and thus to spectral elements of the Raman band. Taking the mean values of the product signals for the first three such spectral elements, SE1, SE2, SE3, to produce the peaked curve 2400 by integration, the first value for the peaked curve 2400 is a mean value of the product signal for the first spectral element SE1. The second value for the peaked curve 2400 is the sum of the mean values of the product signals for the first two spectral elements, SE1 and SE2. The third value for the peaked curve 2400 is the sum of the mean values of the product signals for the first three spectral elements SE1, SE2 and SE3. This method is applied across the whole switchback curve 1000 to obtain the peaked curve 2400.

It will be understood that the method could be applied in either “direction” across the switchback curve 1000 but if it is applied to the negative section first, the result will still enhance the representation of a Raman band but as a negative trough rather than a positive peak.

The numerical integration method is carried out across the whole spectral range, not just the portions which show switchback curve character. However, only the portions with the switchback character build identifiable peaks and it is these which show the presence of Raman bands. Between the peaks, the random nature of noise tends to smooth out in the integrated curve.

The resultant spectrum does though have a ‘random walk’ baseline because the mean value in step 5 above will not be the same for all the spectral data points due to random noise and an error factor is introduced which can accumulate as the integration progresses across the spectrum. Nevertheless, the Raman bands will appear with a significantly greater signal to noise ratio than without carrying out such a protocol.

Referring to FIG. 15, again using data relating to a sample having the Raman bands shown in FIG. 6 and data processing as described above in which step 7 is a numerical integration (Method 2), a spectrum is generated in which all four Raman bands 1500, 1505, 1510, 1515 are present but the baseline is effectively a random walk. The data set used here is the same as that described above in relation to FIGS. 11 to 13. In this case, the baseline makes unambiguously identifying the Raman bands difficult as random ‘apparent’ peaks are present that do not exist in the original spectrum. The reason for this is, as mentioned above, that the mean value subtracted at step 5 will be different for each channel. However, the dataset used is also on the limit of detection. If the signal to noise ratio is better, for example the signal being doubled, then a much improved spectrum can be obtained. The parameters of the data sets used in relation to FIGS. 16 to 19, now with twice as much signal but other parameters the same, are:
background scaling: 10,000
spectrum scaling: 1
spectrum oscillation period: 20 time units (pixels)
spectrum oscillation amplitude “a”: 2 wavenumber units (pixels)
integration time: 262144
shot noise: 1σ

Referring to FIG. 16, the spectrum that would be obtained from a data set with the increased signal, using a conventional Raman spectroscopy method, does show the Raman bands 1600, 1605, 1610, 1615 but the level of noise is very high, making the bands difficult to distinguish.

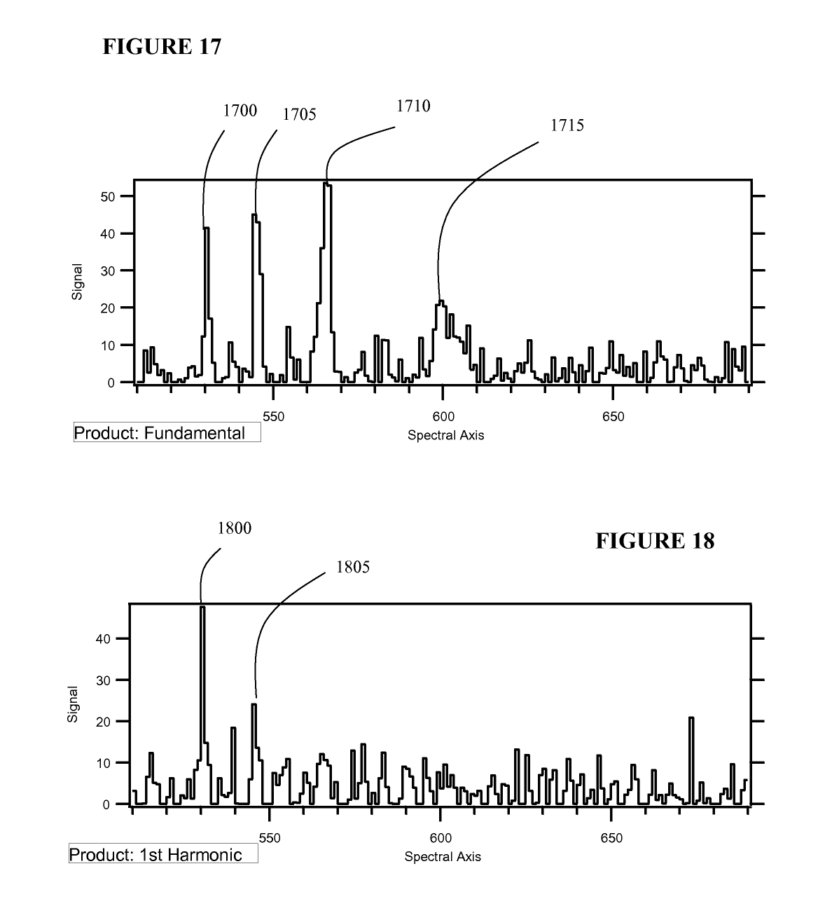

Referring to FIG. 17, the spectrum obtained using sinusoidal oscillation of the excitation wavelength and reference signal, and the fundamental frequency only, and using Method 1 described above—the offset method, shows the three narrower Raman bands 1700, 1705, 1710 well but the broader band 1715 is only distinguished with difficulty.

Referring to FIG. 18, using the first harmonic only, and using Method 1, the two narrowest bands 1800, 1805 are clearly present. Depending on what the Raman spectrum is to be used for, this could be a useful result in itself but usually it would be preferred to detect as many bands as possible.

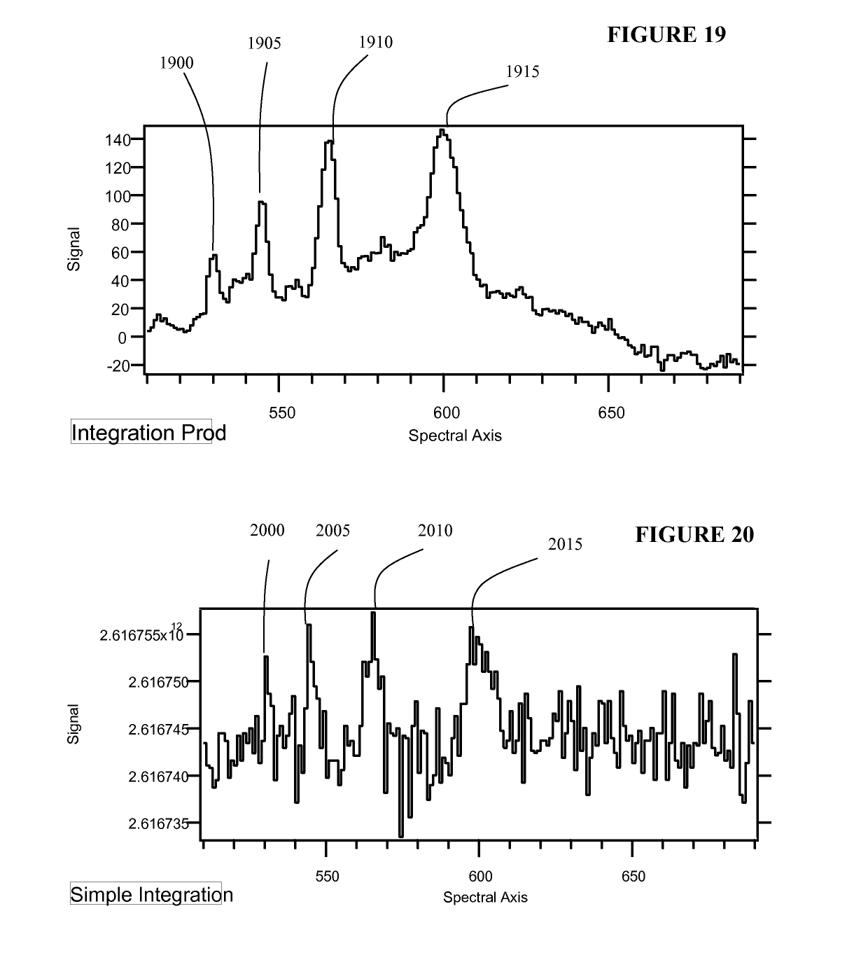

Referring to FIG. 19, a very good spectrum is achieved when using Method 2—the numerical integration—for the case with increased signal to noise, although the Raman bands are broadened to some degree (this is readily apparent for the narrow band 1900).

Referring to FIGS. 20 to 23, the spectra obtained when the amplitude of oscillation is doubled to four channels 125 (pixels) are shown. These spectra are relevant to a data set which is the same as for the spectra shown in FIGS. 16 to 19 except for the change in amplitude of oscillation.

Referring to FIG. 20, again using a conventional Raman spectroscopy method, the Raman bands 2000, 2005, 2010, 2015 are clearly present in the spectrum but the level of noise is still high, making the bands difficult to distinguish.

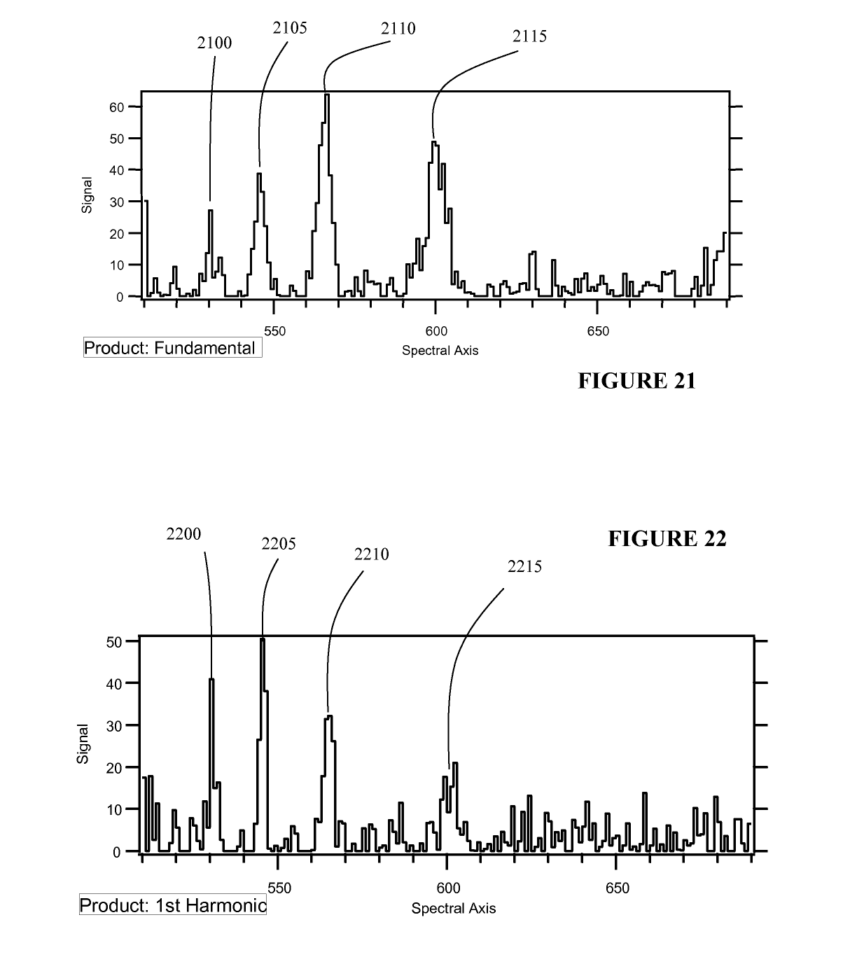

Referring to FIG. 21, using sinusoidal oscillation and reference signal and the fundamental frequency products, and using the first method of analysis—the offset method, a clear representation of all four Raman bands 2100, 2105, 2110, 2115 is achieved.

Referring to FIG. 22, using the first harmonic only, and using the first method of analysis—the offset method, produces a spectrum with the narrower bands 2200, 2205 emphasised but the broader bands 2210, 2215 slightly suppressed.

Referring to FIG. 23, using sinusoidal oscillation and reference signal, and using the second method of analysis—the numerical integration, produces a spectrum with all four Raman bands 2300, 2305, 2310, 2315 very clearly distinguishable, albeit somewhat broadened (especially the narrower bands 2300, 2305). It can be seen that the numerical integration method produces a particularly good extracted Raman signal once there is sufficient signal to detect.

The results shown in FIGS. 16 to 19 compared with those of FIGS. 20 to 23 are a good demonstration of the effect of wavelength modulation amplitude “a”. The amplitude “a” is doubled for the second set of Figures.

In general, Raman bands that are intrinsically narrow will be effectively broadened by the amplitude of the oscillation of the excitation wavelength in embodiments of the invention. This is inevitable as the representation of each Raman band is always, as described above, made in relation to spectral elements which are at least spread across the peak-to-peak wavelength range of the illumination. Using numerical integration (Method 2), the Raman bands will each be spread beyond that wavelength range by half the width of the Raman band at either end of the wavelength oscillation.

The best results are achieved when the peak-to-peak wavelength range of the oscillating illumination is approximately equal to the width of the Raman band. Embodiments of the invention depend on seeing a distinctive change in the mean value of intensity measurements over time for the spectral channels 125. If the peak-to-peak wavelength range of the oscillating illumination is mismatched to the width of a Raman band, the size of the intensity changes over time will be reduced. Either the intensity will tend to stay high (Raman band broad relative to the wavelength oscillation) or it will for a larger proportion of time stay low (Raman band narrow relative to the wavelength oscillation). The biggest change in intensity, making the Raman band most detectable, is when the wavelength oscillation produces a movement in the Raman band across the detectors 120 which is of the order of its own width.

If for example an embodiment of the invention is being used to detect a Raman band of unknown width, or if it is known that there may be Raman bands present that have significantly different widths, then it may be preferable to use illumination radiation which has a relatively complex variation in wavelength. It is straightforward to envisage encoding a wavelength amplitude oscillation in the illumination radiation to incorporate several amplitudes and to use matching algorithms to extract the multiple bandwidth spectra from this mixed driver. This would make Method 1, the offset method, applicable to a broader range of Raman bandwidths. For example, one can oscillate the wavelength using a superposition function such as sine frequency P plus sine frequency Q, each with different amplitudes, then look at the resultant signal at each frequency in turn to extract the Raman band whose width best matches the corresponding amplitude. In the case of a square wave modulation of the illumination, one might incorporate a third and perhaps further wavelengths in order to incorporate oscillations of different amplitudes. Such arrangements may be thought of as analogous to amplitude modulated radio signals.

1. An apparatus for detecting one or more Raman bands in radiation emitted by a sample in response to illumination which oscillates in wavelength over an illumination wavelength range, the emitted radiation being detected as a set of discrete detection signals over a wavelength range, the apparatus comprising a signal processor arranged to:
a) extract time-dependent intensity signals from the detection signals;
b) for the time-dependent intensity signals, determine signals that have a temporal correspondence to illumination of the sample at a selected wavelength or wavelength portion of the illumination range, and derive a mean value over time for each such signal; and
c) generate Raman band data values from said derived mean values, the step of generating at least one of the Raman band data values comprising selecting at least two derived mean values and combining them to obtain an enhanced data value.

2. The apparatus according to claim 1, further comprising an illumination source for illuminating the sample, which source is controllable to oscillate in wavelength over an illumination range of the same order as the width of at least one Raman band to be detected.

3. The apparatus according to any one of claims 1-2, further comprising a wavelength-sensitive detection arrangement for detecting the intensity of electromagnetic radiation emitted by the illuminated sample at a plurality of detection wavelengths or wavelength ranges, offset from the illumination wavelength range, to give said set of discrete detection signals.

4. An apparatus for performing Raman spectroscopy by generating data values for respective spectral elements of a spectral representation of one or more Raman bands, the apparatus comprising:
i) an illumination source for providing narrow band electromagnetic radiation illumination of a sample, the illumination oscillating in wavelength over an illumination wavelength range comparable to the width of a Raman band;
ii) a wavelength-sensitive detection arrangement for detecting the intensity of electromagnetic radiation emanating from the illuminated sample at a plurality of detection wavelengths or wavelength ranges, offset from the illumination wavelength range, to give a set of detection signals; and
iii) a detection signal processor the detection signal processor being arranged to process the detection signals by:
a) extracting a set of time-dependent intensity signals from respective detection signals;
b) for the time-dependent intensity signals, determining signals that have a temporal correspondence to the wavelength of the illumination of the sample, and deriving a mean value over time for each such signal; and
c) generating the data values for respective elements of the spectral representation of one or more Raman bands from said derived mean values, the step of generating at least one of the data values comprising selecting at least two derived mean values and combining them to obtain an enhanced data value.

5. The apparatus according to any one of claim 1 or 4 wherein the illumination wavelength range is not more than ten times the spectral range of the broadest Raman band to be represented.

6. The apparatus according to any one of claim 1 or 4 wherein the illumination wavelength range is not more than 50% different from the spectral range of the broadest Raman band to be represented.

7. The apparatus according to any one of claim 1 or 4 wherein the signal processor is arranged to extract a time-dependent intensity signal by subtracting a mean value from the detection signal to create a signal which varies above and below zero.

8. The apparatus according to any one of claim 1 or 4 wherein the signal processor is arranged to determine components that correspond to the oscillation of the source by multiplying each extracted time-dependent signal by a reference signal to create a product signal, the reference signal comprising a frequency corresponding to a frequency of the wavelength oscillation of the source.

9. The apparatus according to claim 8, wherein the reference signal comprises a fundamental frequency corresponding to a fundamental frequency of the wavelength oscillation of the source.

10. The apparatus according to claim 8 wherein the reference signal comprises a harmonic frequency of a fundamental frequency of the wavelength oscillation of the source.

11. The apparatus according to claim 9 wherein the signal processor is arranged to select and combine at least two derived mean values by summing the derived mean values in an integration process across all the detection signals so as to generate data supporting the spectral representation of one or more Raman bands.

12. The apparatus according to claim 9 wherein the signal processor is arranged to select and combine at least two derived mean values by:
creating a data store having at least one set of data locations each assigned to a respective one of said spectral elements, and
assigning the magnitude of each derived mean value to a selected one of the data locations, selection of a data location being determined at least partially in accordance with whether the mean value is positive or negative, such that at least one data location is assigned the magnitudes of more than one derived mean value.

13. The apparatus according to claim 12 wherein selection of a data location may further be determined by a spectral offset value such that the magnitude of a derived mean value arising in relation to a first spectral position might be assigned to a data location which itself is assigned to a spectral element of different wavelength for the purpose of the spectral representation.

14. The apparatus according to claim 13 wherein the component of each time-dependent signal that corresponds to the oscillation of the source is at a fundamental frequency of the oscillation and the offset value has constant magnitude but is positive or negative in accordance with whether the derived mean value is positive or negative.

15. The apparatus according to claim 13 wherein the component of each time-dependent signal that corresponds to the oscillation of the source is at a first harmonic of a frequency of the oscillation and the offset value is only applied to selection of the data location in the case where the derived mean value is negative.

16. The apparatus according to claim 8 wherein the reference signal is supplied, in use, to the illumination source so as to generate the wavelength oscillation.

17. The apparatus according to claim 8 wherein the reference signal has at least a square wave component.

18. The apparatus according to claim 8 wherein the reference signal has at least a sinusoidal component.

19. The apparatus according to claim 12 wherein the at least one set of data locations covers a section of the spectral range not more than the peak-to-peak range of the wavelength oscillation.

20. The apparatus according to claim 13 wherein the offset value is the amplitude of the wavelength oscillation of the illumination radiation.

21. An apparatus according to claim 8, wherein the illumination source is arranged to provide illumination which oscillates in wavelength over time, the oscillation having at least two different frequency components, each frequency component having a respective amplitude in wavelength which is different from the amplitude of the other frequency component or components, and wherein the reference signal source is arranged to provide one or more reference signals having components that match said two different frequency components of the wavelength oscillation.

22. A method of detecting one or more Raman bands in radiation emitted by a sample in response to illumination which oscillates in wavelength over an illumination wavelength range, the emitted radiation being detected as a set of discrete detection signals over a wavelength range, the method comprising:
a) extracting time-dependent intensity signals from the detection signals;
b) for the time-dependent intensity signals, determining components that have a temporal correspondence to illumination of the sample at a selected wavelength or wavelength range of the oscillating illumination and deriving a mean value over time for each such component; and
c) generating Raman band data values from said derived mean values, the step of generating at least one of the Raman band data values comprising selecting at least two derived mean values and combining them to obtain an enhanced data value.

23. The method according to claim 22, further comprising illuminating the sample with radiation which oscillates in wavelength over a wavelength range of the same order as the width of at least one Raman band to be detected.

24. The method according claim 22, further comprising detecting the intensity of electromagnetic radiation emitted by the illuminated sample at a plurality of detection wavelengths or wavelength ranges, each detection wavelength or wavelength range being outside the illumination wavelength range, to give said set of discrete detection signals.
